(19) United States
(12) Patent Application Publication
(10) Pub. No.: US 2013/0011027 A1
(43) Pub. Date: Jan. 10, 2013

(54) SYSTEM AND METHOD FOR COMPOSING A MEDICAL IMAGE ANALYSIS

(76) Inventor: Sonja Zillner, Munchen (DE)

(21) Appl. No.: 13/247,123

(22) Filed: Sep. 28, 2011

(30) Foreign Application Priority Data
Jul. 5, 2011 (EP) 11172675

(51) Int. Cl. G06K 9/46

(52) U.S. Cl. 382/128

(57) ABSTRACT

A method composing a medical image analysis, includes the steps of: retrieving anatomical findings captured in a medical report by an information extraction module; providing at least one anatomical knowledge model including a plurality of concepts and a plurality of relationship between the plurality of concepts; mapping at least one anatomical finding of the medical re-port by at least one of the plurality of concepts by a mapping component, thereby locating the anatomical findings in the context of the anatomical knowledge model; and; representing the anatomical findings in the context of the anatomical knowledge model within an anatomical model by a visualization component.

### CROSS-REFERENCE TO RELATED APPLICATIONS

This application claims priority to EP Patent Application No. 11172675 filed Jul. 5, 2011, the contents of which is incorporated herein by reference in its entirety.

### TECHNICAL FIELD

The invention provides a method for composing a medical image analysis.

### BACKGROUND

Medical image diagnosis is generally understood as a process of extracting and interpreting relevant information units from a given medical image. Medical images include images obtained by computer tomography, magnetic resonance imaging or ultrasonography etc. Such medical images provide information about morphology, function and metabolism of a human body and have become indispensable for detecting and differentiating pathologies, planning interventions and monitoring treatments. At the same time, medical image modalities have matured both with regard to image quality and ease of use and various new post processing applications become available.

Medical diagnosis by means of medical images requires accurate and comprehensive domain knowledge which is usually accomplished by medical experts including radiologists. Due to the complexity of the medical domain and the comprehensiveness of medical images, such diagnosis is highly demanding for radiologists.

Radiologists usually summarize their findings in so-called radiology reports. A radiology report is a textual description of the contents and/or interpretation of a medical image. The textual description highlights the facts that are relevant in the context of the given patient history and clinical assumption. Technically, radiology reports encompass a list of image findings that are relevant, i.e. need to be mentioned, for a particular diagnosis.

Such radiology reports, however, have remarkable deficiencies in clearly visualizing of essential findings. These deficiencies are mainly due to the textual nature of radiology reports and medical reports in general. Additionally, such medical reports do not represent medical findings in a commonly acknowledged structure, nor do they obey a common sense of grammar. For instance, the sentences lack verbs and punctuations, an almost inflationary use of abbreviations is being made and temporal and spatial information for describing image content is used extensively.

Hence, there is a need in the art for post-processing means by which the contents of a medical report are represented in a readily comprehensible manner for each clinician which has to analyze the contents of this report with regard to the medical image.

### SUMMARY

According to various embodiments, a method of composing a medical image analysis based on a medical report can be provided.

According to other embodiments, anatomical statements can be mapped within the medical report to a commonly comprehensible concept.

According to yet other embodiments, an analysis which is immediately intelligible for each clinician can be provided, whereby medical findings are to be represented in an organized fashion.

According to an embodiment, a method for composing a medical image analysis, may comprise the steps of: —providing an information extraction module, the information extraction module retrieving anatomical findings captured in a medical report; —providing at least one anatomical knowledge model from a memory unit, the anatomical knowledge model including a plurality of concepts and a plurality of relationship between said plurality of concepts; —providing a mapping component, the mapping component mapping at least one anatomical finding of said medical report by at least one of the plurality of concepts, thereby locating said anatomical findings in the context of said anatomical knowledge model; and—providing a visualization component, the visualization component representing said anatomical findings in the context of said anatomical knowledge model within an anatomical model.

According to a further embodiment, the method may comprise the step of juxtaposing said anatomical findings with past anatomical findings within said anatomical model. According to a further embodiment, the method may comprise the step of visualizing differences between current anatomical findings and past anatomical findings. According to a further embodiment, the method may comprise the step of juxtaposing said anatomical findings with anatomical findings related to an average group of similar patients. According to a further embodiment, the method may comprise the step of visualizing differences between said anatomical findings and past anatomical findings. According to a further embodiment, said knowledge model can be formed by at least one of a group of resources, the group of resources including an ontology, a taxonomy, a thesaurus, an ontology, a dictionary, a set of keywords and a lexicon.

According to an embodiment, a computer program product may contains a program code stored on a computer-readable medium which, when executed on a computer, carries out the method as described above.

According to yet another embodiment, a system for composing a medical image analysis, may comprise: —an information extraction module for retrieving anatomical findings captured in a medical report; —a memory unit storing an anatomical knowledge model including a plurality of concepts and a plurality of relationship between said plurality of concepts; —a mapping component for mapping at least one anatomical finding of said medical report by at least one of the plurality of concepts, thereby locating said anatomical findings in the context of said anatomical knowledge model; and; —a visualization component for representing said anatomical findings in the context of said anatomical knowledge model within an anatomical model.

### BRIEF DESCRIPTION OF THE DRAWINGS

These and other objects and advantages will become more apparent and readily appreciated from the following description of embodiments, taken in conjunction with the accompanying drawing.

Reference will now be made in detail to embodiments, examples of which are illustrated in the accompanying drawing.

FIG. 1 shows a self-explanatory schematic view of the proposed method. A radiology report as a particular example of a general medical report is depicted on the far left side.

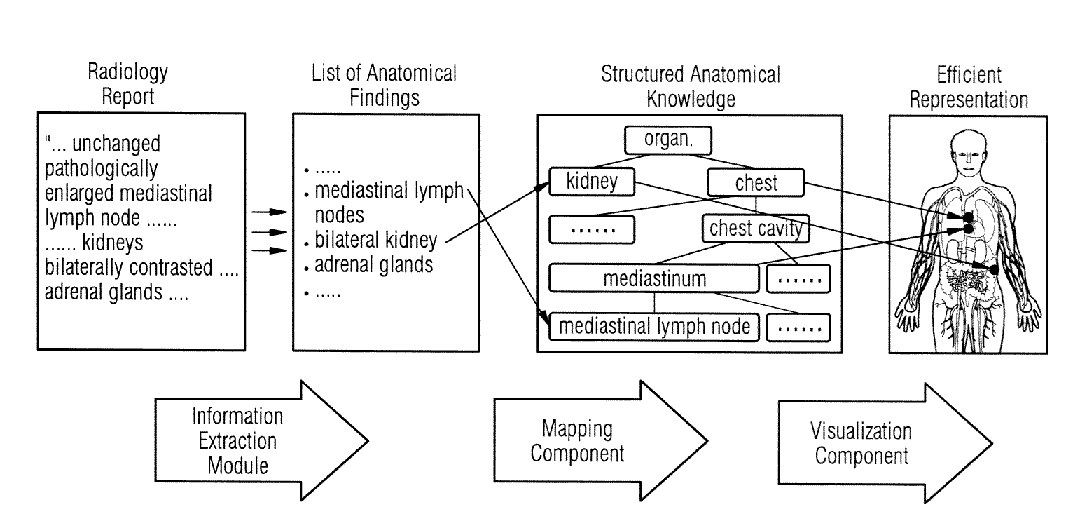

### DETAILED DESCRIPTION

According to various embodiments, a method may compose a medical image analysis, wherein the method comprises the steps of retrieving anatomical findings captured in a medical report by an information extraction module; providing at least one anatomical knowledge model including a plurality of concepts and a plurality of relationship between said plurality of concepts; mapping at least one anatomical finding of said medical re-port by at least one of the plurality of concepts by a mapping component, thereby locating said anatomical findings in the context of said anatomical knowledge model; and; representing said anatomical findings in the context of said anatomical knowledge model within an anatomical model by a visualization component.

The various embodiments are generally aiming to provide an anatomical model as the basis for a structured representation of the findings.

By retrieving anatomical findings—which particularly include a respective position within a human body—of a medical report and mapping these findings to a knowledge model—in particular an ontology and/or a thesaurus—and mapping respective anatomical finding by a respective concept of the knowledge model, the various embodiments allow a mapping of anatomical statements within the medical report to a commonly comprehensible concept.

The visualization component, finally, represents said anatomical findings in the context of said anatomical knowledge model within the anatomical model. The anatomical model may include or consist of the medical image itself as instance concept, which may be enriched by landmarks displaying the findings in their anatomical, i.e. topographical context.

In a possible embodiment of the method, the method comprises a juxtaposition of said current anatomical findings with past anatomical findings within said anatomical model. These past anatomical findings may be stored in a memory which is assigned to a patient's file.

In a further possible embodiment of the method, the representation of the visualization component includes a visualization of differences between current anatomical findings and past anatomical findings, including, for example emphasizing outlines of a pathologically enlarged organ.

In a possible embodiment of the method, the method comprises a juxtaposition of anatomical findings with anatomical findings related to an average group of similar patients. This embodiment allows a straight-away analysis of pathological alterations in view of a peer group.

Provided by an information extraction module, a list of anatomical findings captured in a medical report is retrieved and listed in the depicted list of anatomical findings. This output list of anatomical findings contains anatomical findings that were covered within the medical report. The algorithm used for extracting the list of anatomical findings is based on a combination and refinement of existing technologies for text-mining and language processing.

Provided by a mapping component, the anatomical findings are mapped by concepts of a structured anatomical knowledge model. The mapping component allows mapping the extracted information representing anatomical findings onto a standardized and customized anatomical terminology using a knowledge model or domain model.

The anatomical terminology used therein relies on existing anatomy and radiology domain models, such as FMA Ontology or RadLex Thesaurus.

An ontology is understood as a formal specification of terminology and concepts, as well as the relationships among those concepts, relevant to a particular domain or area of interest. Ontologies provide insight into the nature of information particular to a given field and are essential to any attempts to arrive at a shared understanding of the relevant concepts. They may be specified at various levels of complexity and formality depending on the domain and information needs of the participants in a given conversation.

The knowledge model captures structural, relational, spational and/or regional information such that identified anatomical positions can be automatically mapped onto their higher-ranked regional position and/or organ system.

A visualization component, finally, provides an efficient representation of the anatomical findings mapped by concepts within the anatomical knowledge model. The representation is provided within an anatomical model.

Various embodiments of representing information of the anatomical findings are possible:
Direct Representation of Findings: The list of findings is visually represented;
Representation of Changed Finding: The current list is compared to historical results of the same patient, i.e. with the list of findings of one or more past examinations of the same patient. The difference in findings is visualized by the visualization component;
Comparison with Average Findings: The current list of findings is compared to the average results of a set of similar patients, i.e. with the list of findings that get extracted in the majority of case of similar patients, including patients having similar diseases. The comparison result is visualized by the visualization component;
Comparison with remaining list of findings: Findings which are not yet mentioned are visualized by the visualization component. The user/radiologist is able to select the visualization mode which is most helpful and appropriate to her or him.

Due to vast progresses in medical images devices, clinicians today rely deeply on images for screening, diagnosing, treatment planning and follow up.

Today, medical images from various modalities such as computer tomography, magnetic resonance imaging or ultrasonography provide information about morphology, function and metabolism of the human body and have become indispensable for detecting and differentiating pathologies, planning interventions and monitoring treatments. At the same time, medical image modalities have matured both with regard to image quality and ease of use, and various new post processing applications become available.

In the context of clinical image analysis, radiologists summarize their findings in so-called radiology reports. A radiology reports is the textual description of the content of the medical image. The textual description highlights the facts that are relevant in the context of the given patient history and clinical assumption. Technically, radiology reports encompass a list of image findings that are relevant, i.e. need to be mentioned for a particular diagnosis of a particular patient. Image finding consist of three different information categories:
Anatomical/spatial information detailing the location of the finding;
Pathological information detailing how the finding can be clinically interpreted reflecting the clinical hypothesis;
Temporal information detailing how the finding developed and/or changed over time.

For each finding, the anatomical information serves as anchor point, i.e. as identifier, whereas the pathological and temporal information relate to an anatomical location allowing a specification of the indicated anatomical location in more detail. In other words, the list of anatomical findings refers to the various anatomical locations in the medical image depicting the human body that need to be tracked and observed carefully as they capture information content that might make a difference in the progress of diagnosis finding.

The proposed method introduces an approach for the efficient monitoring of the clinical diagnosis process of medical images to improve the quality and completeness of clinical image diagnosis.

In order to enable the quality control of the medical images analysis in terms of completeness and quality, an efficient and clearly arranged representation of the summary of the reports is required.

The proposed method introduces a mechanism that allows extracting and monitoring the key aspects, i.e. a list of identified anatomical locations of radiology reports.

In order to enhance the extracted information, e.g. the list of identified anatomical locations, can be compared to past results (i.e. extracted locations of past reports), to average results (likely locations in the context of this particular disease) or missed results (anatomical locations not mentioned in this report).

The proposed method and its embodiments establish a mechanism that combines means for information extraction, with information mapping and intelligent information visualization in the context of human-driven medical image analysis.

The inventor has also faced the current clinical practice. For capturing the content of medical images, radiologist dictate observed findings. The dictated text is usually transferred into written form.

Although radiology reports are stored as written documents, they do not follow the general way of grammar. For instance, the sentences lack verbs and punctuations, an almost inflationary use of abbreviations is being made and temporal and spatial information for describing image content is used extensively. Thus, means for automatic extraction of knowledge from radiology reports have to address those textual particularities.

In order to improve an automatic extraction of the knowledge captured in radiology reports, a mapping between >>two languages<< is necessary. The language of the radiology reports and the language of radiology domain model, for instance the RadLex Taxonomy. Both languages are lacking completeness and formal structuring.

For being able to establish high-quality mapping between radiology reports and RadLex terms, one could control the language used by the radiologist. This could be achieved by using input templates that guide the content being provided by the radiologist and that restrict the usage of medical expressions to terms known by the system. But, as the clinical diagnosis and interpretation of medical images is a very context-dependent and complex task, any technical means aiming for reducing complexity, such as the mentioned template approach, is counter productive to the art of diagnosis aiming to discover very specific and detailed information units carrying a particular meaning in this particular context.

Therefore, radiologists do not accept a usage of templates when analyzing medical image content. Usually clinicians decline any restriction in their diagnosis process. Currently no approach exists, which supports clinicians in monitoring the quality and completeness of their image analysis report.

The proposed method introduces an approach for the efficient monitoring of the clinical image analysis in the context of the clinical screening, diagnosis, treatment planning and follow up. By monitoring the clinical image analysis process, an improvement in terms of quality and completeness is aimed.

Although known methods are partially supporting a semi-automated analysis of medical images, the human experts' opinion and diagnosis is mandatory when diagnosing the health of human beings. Due to the sensitive character of clinical knowledge, means for monitoring and controlling the quality and completeness of the extracted information of medical images are required.

The proposed method introduces an approach for the efficient monitoring of the clinical image analysis in the context of the clinical screening, diagnosis, treatment planning and follow up. By monitoring the clinical image analysis process, an improvement in terms of quality and completeness is aimed.

One particular advantage of the proposed method is in a clearly arranged visualization of essential information by indicating relevant anatomical locations in the context of a particular patient and disease. This visualization reflects diagnosis result and performance in terms of completeness and quality. By means of the proposed method, clinicians are enabled to immediately comprehend the very relevant information, i.e. the list of clinical findings represented by highlighted anatomical locations.

A further particular advantage of the proposed method is in the efficient comparison of the current data sets, i.e. medical findings, with alternative data sets, including data sets of past clinical findings, average case findings, missing findings, etc. By means of the comprehensive visualization, the clinician is able to compare the current diagnosis, which is represented by a list of anatomical locations having been important to look at, with past or average findings. By means of flexible user interaction mechanism, the clinician can automatically select the representation that is most valuable to her or him.

What is claimed is:

1. A method for composing a medical image analysis, the method comprising the steps of:
providing an information extraction module, the information extraction module retrieving anatomical findings captured in a medical report;
providing at least one anatomical knowledge model from a memory unit, the anatomical knowledge model including a plurality of concepts and a plurality of relationship between said plurality of concepts;
providing a mapping component, the mapping component mapping at least one anatomical finding of said medical report by at least one of the plurality of concepts, thereby locating said anatomical findings in the context of said anatomical knowledge model; and;
providing a visualization component, the visualization component representing said anatomical findings in the context of said anatomical knowledge model within an anatomical model.

2. The method according to claim 1, further comprising the step of juxtaposing said anatomical findings with past anatomical findings within said anatomical model.

3. The method according to claim 2, further comprising the step of visualizing differences between current anatomical findings and past anatomical findings.

4. The method according to claim 1, further comprising the step of juxtaposing said anatomical findings with anatomical findings related to an average group of similar patients.

5. The method according to claim 4, further comprising the step of visualizing differences between said anatomical findings and past anatomical findings.

6. The method according to claim 1, wherein said knowledge model is formed by at least one of a group of resources, the group of resources including an ontology, a taxonomy, a thesaurus, an ontology, a dictionary, a set of keywords and a lexicon.

7. A computer program product comprising a computer readable medium storing a program code which, when executed on a computer, performs the steps of:
providing an information extraction module, the information extraction module retrieving anatomical findings captured in a medical report;
providing at least one anatomical knowledge model from a memory unit, the anatomical knowledge model including a plurality of concepts and a plurality of relationship between said plurality of concepts;
providing a mapping component, the mapping component mapping at least one anatomical finding of said medical report by at least one of the plurality of concepts, thereby locating said anatomical findings in the context of said anatomical knowledge model; and;
providing a visualization component, the visualization component representing said anatomical findings in the context of said anatomical knowledge model within an anatomical model.

8. The computer program product according to claim 7, wherein said anatomical findings are juxtaposed with past anatomical findings within said anatomical model.

9. The computer program product according to claim 8, wherein differences between current anatomical findings and past anatomical findings are visualized.

10. The computer program product according to claim 7, wherein said anatomical findings are juxtaposed with anatomical findings related to an average group of similar patients.

11. The computer program product according to claim 10, wherein differences between said anatomical findings and past anatomical findings are visualized.

12. The computer program product according to claim 7, wherein said knowledge model is formed by at least one of a group of resources, the group of resources including an ontology, a taxonomy, a thesaurus, an ontology, a dictionary, a set of keywords and a lexicon.

13. A system for composing a medical image analysis, the system including:
an information extraction module for retrieving anatomical findings captured in a medical report;
a memory unit storing an anatomical knowledge model including a plurality of concepts and a plurality of relationship between said plurality of concepts;
a mapping component for mapping at least one anatomical finding of said medical report by at least one of the plurality of concepts, thereby locating said anatomical findings in the context of said anatomical knowledge model; and;
a visualization component for representing said anatomical findings in the context of said anatomical knowledge model within an anatomical model.

14. The system according to claim 13, wherein the system is configured to juxtapose said anatomical findings with past anatomical findings within said anatomical model.

15. The system according to claim 14, wherein the system is configured to visualize differences between current anatomical findings and past anatomical findings.

16. The system according to claim 13, wherein the system is configured to juxtapose said anatomical findings with anatomical findings related to an average group of similar patients.

17. The system according to claim 16, wherein the system is configured to visualize differences between said anatomical findings and past anatomical findings.

18. The system according to claim 13, wherein said knowledge model is formed by at least one of a group of resources, the group of resources including an ontology, a taxonomy, a thesaurus, an ontology, a dictionary, a set of keywords and a lexicon.
